(19) United States
(12) Patent Application Publication
(10) Pub. No.: US 2006/0065582 A1
(43) Pub. Date: Mar. 30, 2006

(54) Portable oil filtering apparatus

(76) Inventor: Peter Alan Bell, Regents Park (AU)

Correspondence Address: SHOEMAKER AND MATTARE, LTD, 10 POST OFFICE ROAD - SUITE 110, SILVER SPRING, MD, 20910, US

(21) Appl. No.: 11/231,330

(22) Filed: Sep. 20, 2005

(30) Foreign Application Priority Data
Sep. 21, 2004 (AU) 2004100793

(51) Int. Cl. B01D 29/00

(52) U.S. Cl. 210/167; 210/416.1; 210/DIG. 8

(57) ABSTRACT

The present invention is a portable oil filtering apparatus that can operate independent of external power sources to collect oil from cookers or fryers for disposal or storage and filter oil from the cookers or fryers for re-use. The oil filtering apparatus of the preferred embodiment is able to safely collect and dispose of oil using a sealed container. The oil filtering apparatus of the preferred embodiment is also able to filter oil to remove particulate matter and other contaminants and reintroduce the filtered oil to a cooker and fryer thereby extending the operational life of the oil. In this way the preferred embodiment of the oil filtering apparatus is able to recycle oil from cookers and fryers and thereby save money and reduce the amount of waste oil released into the environment.

### FIELD OF INVENTION

The present invention relates to an apparatus and method for removing oil from an oil source for disposal or filtering for re-use. The present invention has particular but not exclusive application for disposing of or filtering of oil from deep fryers and cookers. Reference in the specification to the use of the apparatus for collecting oil from fryers and cookers is by way of example only and the invention is not limited to this particular use.

### BACKGROUND OF THE INVENTION

Deep fry cooking of foods is a popular method of cooking take-away or fast foods. The cooking of the food is relatively quick compared with other types of cooking. Prepared food is placed in cookers or fryers with pre-heated oil and cooked. Generally, cooking occurs at a frying temperature of 180° C. The food is generally coated in batter or bread crumbs prior to cooking and the coating forms a protective shield during cooking, preventing oil from penetrating the food and making it greasy. The food will usually cook by conduction or indirect heat. If the oil is not hot enough, the coating will not cook and form the protective layer, allowing the oil to contact the food and thereby resulting in greasy food. If the oil is too hot, the coating will burn from the direct heat of the oil before the food has had time to cook.

Furthermore, the oil degrades with use and the smoke point of the particular oil lowers to a level where deep frying temperatures cannot be maintained. The smoke point of the oil is the temperature at which the oil begins to decompose and visible fumes of smoke are released. The oil degrades with use because of a lowering of the saturation levels of the oils and presence of foreign matter such as bread crumbs, batter and salt. The useful life of the cooking oil will depend on the temperatures to which the oil is heated, the number of times the oil is used and the length of time the oil is heated.

Because oil is degraded with use, the oil in deep fryers and cookers need to be changed regularly. This involves removing hot oil from the fryer or cooker through an outlet and disposing of it in an environmentally friendly way and replacing with new oil. The removal of oil from the fryer or cooker is potentially dangerous as hot oil can spill and cause serious burns to a person. Furthermore, other apparatus such as a pump are needed to remove the remaining particulate matter within the fryer or cooker and to introduce the new oil, thereby complicating the procedure and increasing the risk of injury.

### OBJECT OF THE INVENTION

It is an object of the present invention to provide an alternative means for removing oil or filtering oil for reuse from cookers and fryers and overcoming at least in part one or more of the abovementioned disadvantages.

### SUMMARY OF THE INVENTION

In one aspect the present invention broadly resides in a portable oil filtering apparatus for use for filtering oil from an oil source including:
container means for receiving and holding oil from an oil source;
pump means for pumping and discharging oil from container means, said pump means includes a power source and pump; and
filter means for filtering oil before it is discharged by pump means wherein the arrangement of the oil filter apparatus provides an operationally independent unit.

The container means preferably includes a container with an opening that can be positioned adjacent an outlet of the oil source. In one preferred embodiment there is a guide means associated with the opening for guiding oil from the oil source outlet to the container. The guide means may be a funnel, a pipe with a free end connectable to the outlet or an open channel member. In another preferred embodiment the opening has a relatively large diameter enabling the apparatus to be suitably positioned to collect oil irrespective of the location of the oil source outlet.

The container is preferably sealable so that the apparatus can be moved without spilling the collected oil.

The oil filtering apparatus is preferably mobile. The oil filtering apparatus more preferably has one or more wheels enabling the apparatus to be maneuverable for locating in desired positions and mobile to dispose of or store the collected oil.

The pump means preferably includes a hose member which is operationally connected to the container via the pump. The pump is preferably powered by one or more batteries mounted to the apparatus. In a preferred embodiment there is suitable recharging means to charge and maintain the one or more batteries.

The filter means preferably includes one or more filters. The one or more filters may include mesh-like filters for filtering large particulate matter, sieve-like filters which have smaller pore sizes in order to collect finer particulate matter and charcoal filters for collecting chemical contaminants. An oil filter apparatus may have two or more filters which complement each other by filtering different types of matter and contaminants from the oil.

The one or more filters may be associated with the container means and/or the pump means. Preferably there is a filter locatable about the opening of the container. In another embodiment there may be a filter housed within the hose member. Preferably the one or more filters are removable so that they can be cleaned or replaced. In a preferred embodiment the oil filter apparatus has a mesh-like filter locatable about the opening of the container to collect particulate matter as oil is introduced to the container.

Said oil source is preferably cooking oil reservoirs. More preferably the oil source is a deep fryer or cooker.

In another aspect the invention broadly resides in a system for removing oil from an oil source for re-use or disposal using the abovementioned portable oil filter apparatus.

In a further aspect, the invention broadly resides in a method for removing oil from an oil source for disposal or storage, using the abovementioned apparatus, said method including:
positioning said portable oil filtering apparatus adjacent the oil source outlet so that oil discharged from the outlet enters said container means;
opening the oil source outlet to allow oil to discharge;
closing the oil source outlet after the oil has discharged; and
sealing the container means so that oil cannot inadvertently escape while the apparatus is moved for disposal or storage of the oil.

In a further aspect, the invention broadly resides in a method for removing oil from an oil source for filtering for re-use, using the abovementioned apparatus, said method including:
positioning said portable oil filtering apparatus adjacent the oil source outlet so that oil discharged from the outlet enters said container means;
opening the oil source outlet to allow oil to discharge;
closing the oil source outlet after the oil has discharged; and
activating the pump means to filter the oil and reintroducing the filtered oil into the oil source.

The method may also include the step of using the filtered oil to wash any residual particulate matter from the oil source prior to refilling the oil source.

The method may also include the step of introducing new or filtered oil to the oil source to reach the desired oil level in the oil source.

### BRIEF DESCRIPTION OF THE DRAWINGS

In order that the present invention can be more readily understood and put into practical effect, reference will now be made to the accompanying drawings wherein:

FIG. 1 shows a diagrammatic view of the preferred embodiment of the portable oil filter apparatus;

FIG. 2 shows an alternate diagrammatic view of the preferred embodiment of the portable oil filter apparatus;

FIG. 3 is a front diagrammatic view of the preferred embodiment of the portable oil filter apparatus;

FIG. 4 is a rear diagrammatic view of the preferred embodiment of the portable oil filter apparatus;

FIG. 5 is a top diagrammatic view of the preferred embodiment of the portable oil filter apparatus;

FIG. 6 is a bottom diagrammatic view of the preferred embodiment of the portable oil filter apparatus;

FIG. 7 is a photograph showing a top view of the preferred embodiment of the portable oil filter apparatus;

FIG. 8 is a photograph showing a rear view of the preferred embodiment of the portable oil filter apparatus: and

FIG. 9 is a photograph showing the filter within the container of the preferred embodiment of the portable oil filter apparatus.

### DETAILED DESCRIPTION OF THE PREFERRED EMBODIMENT

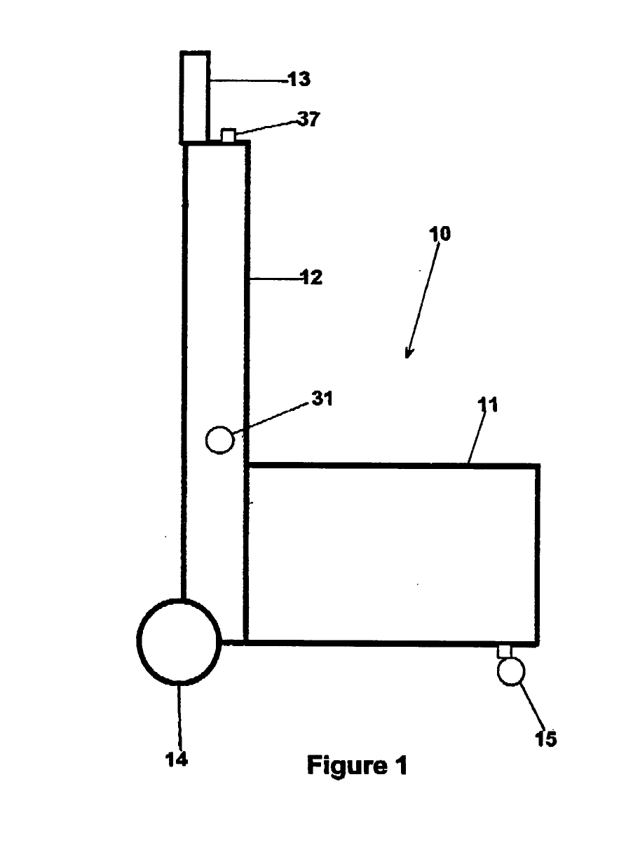

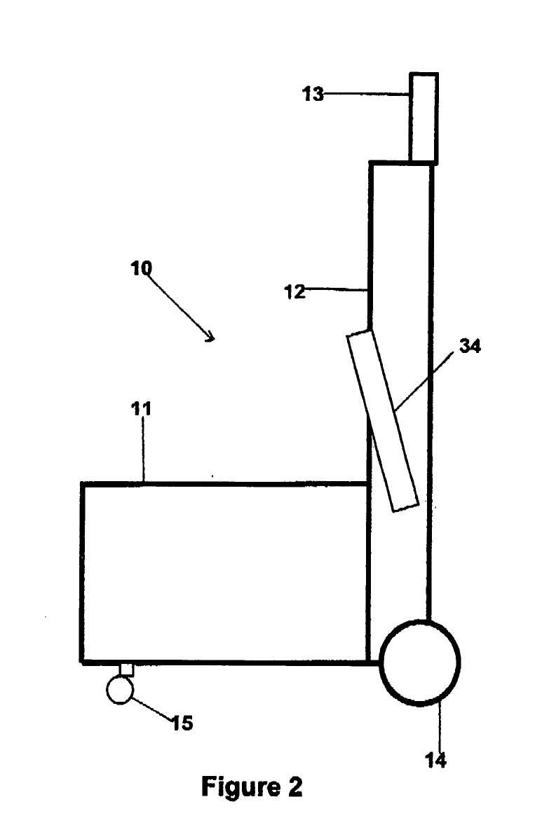

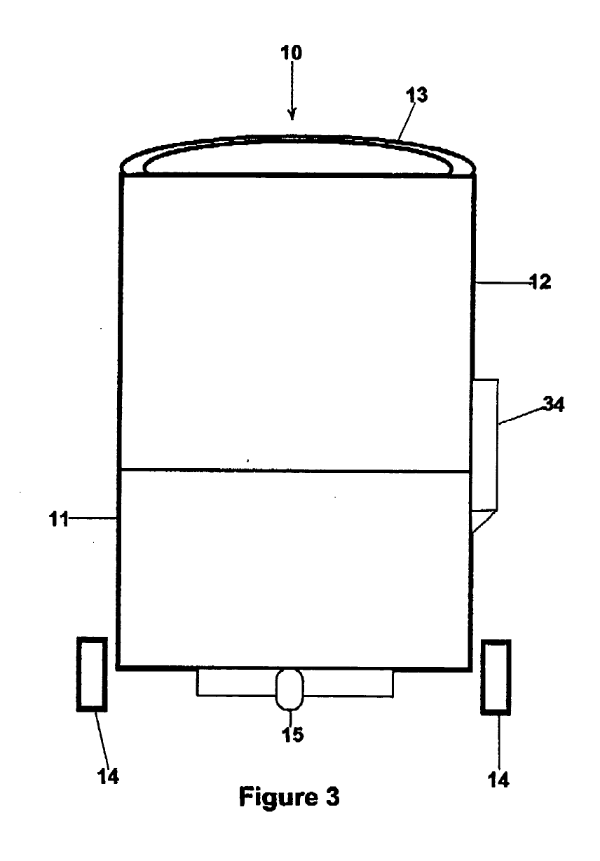

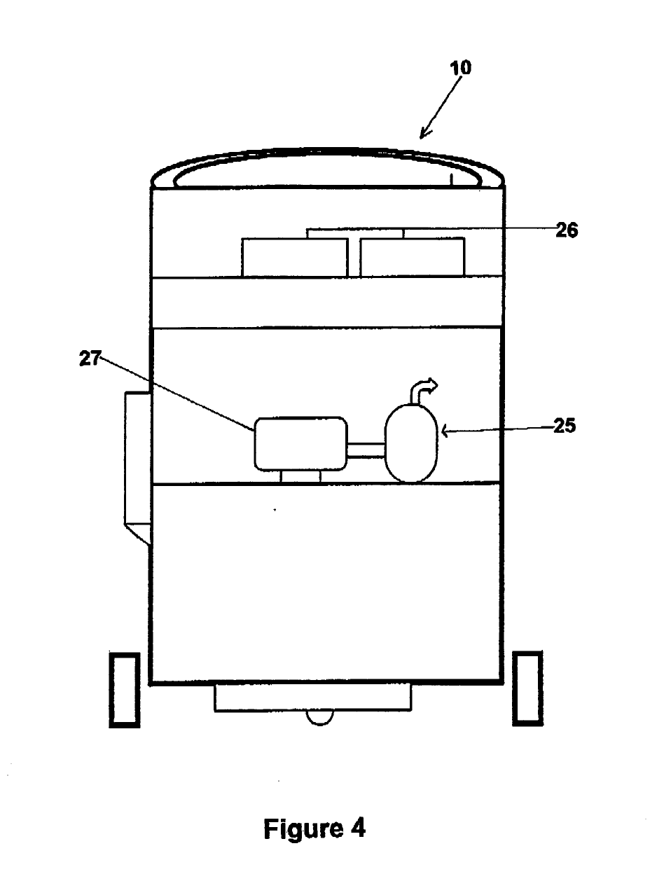

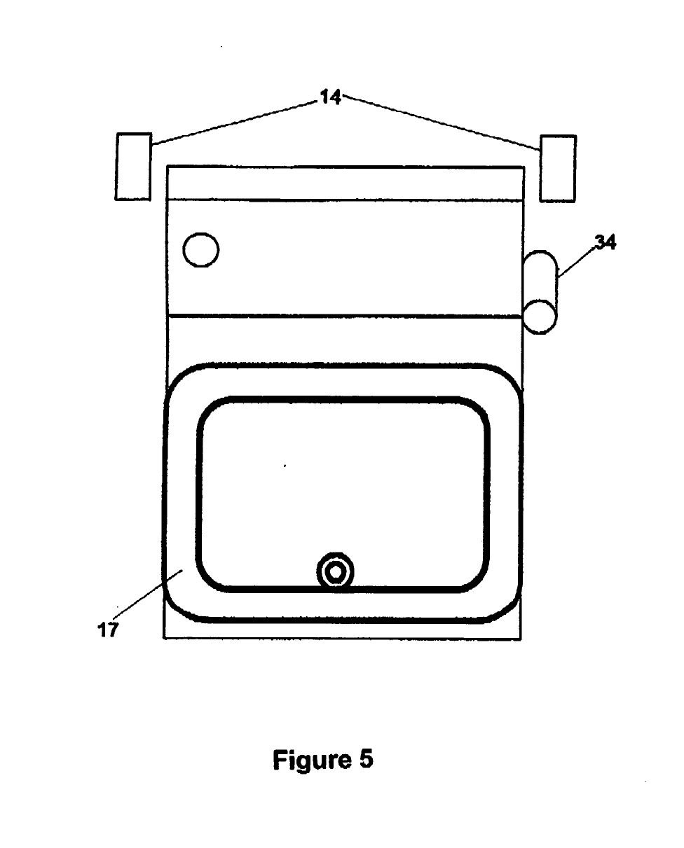

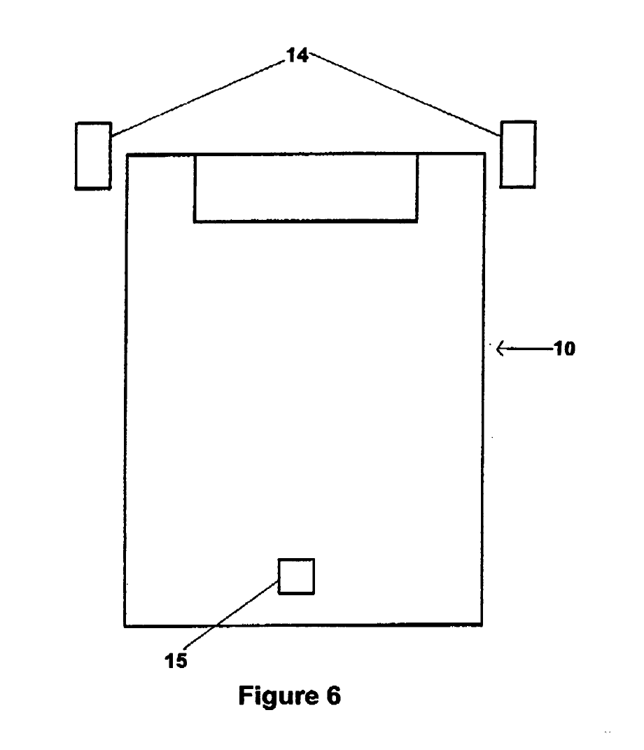

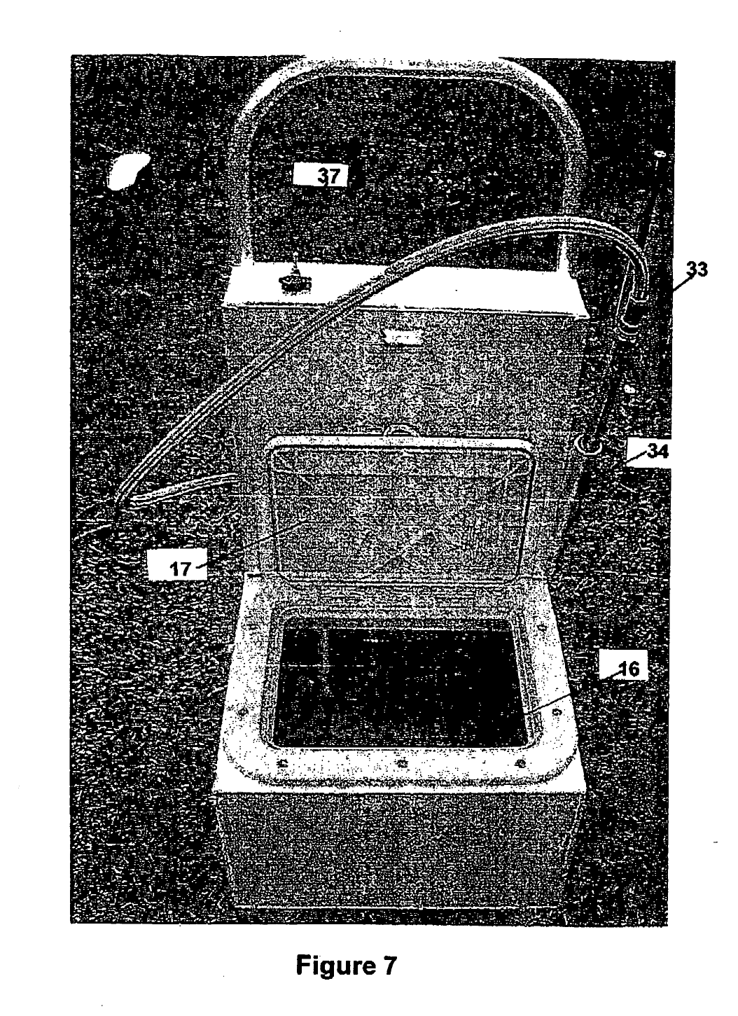

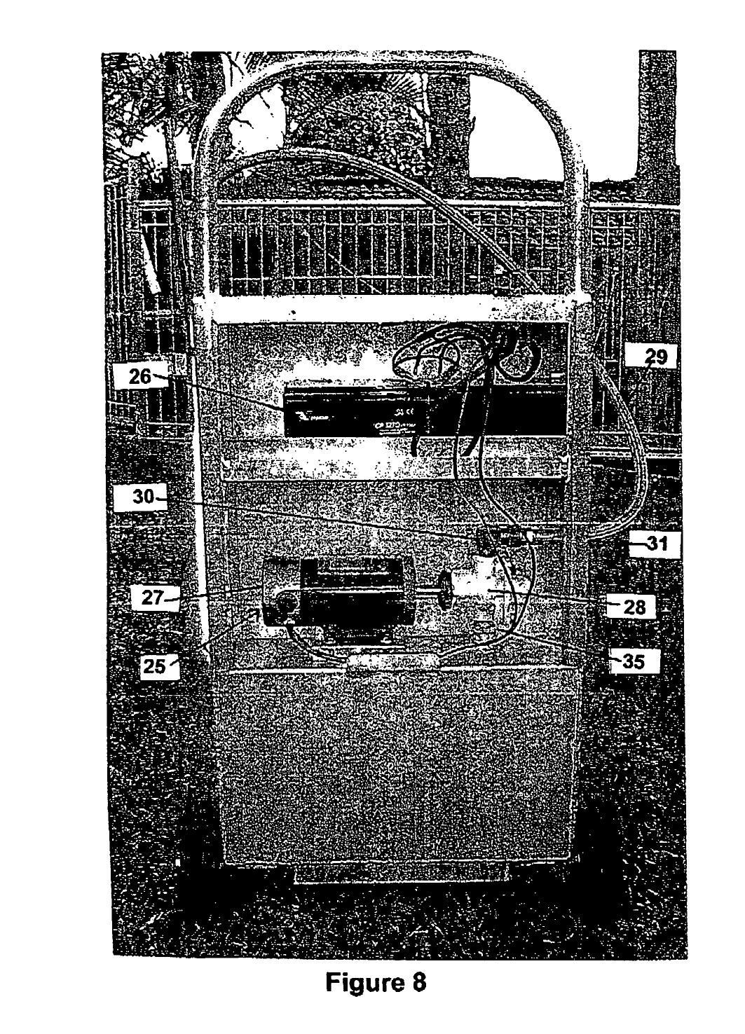

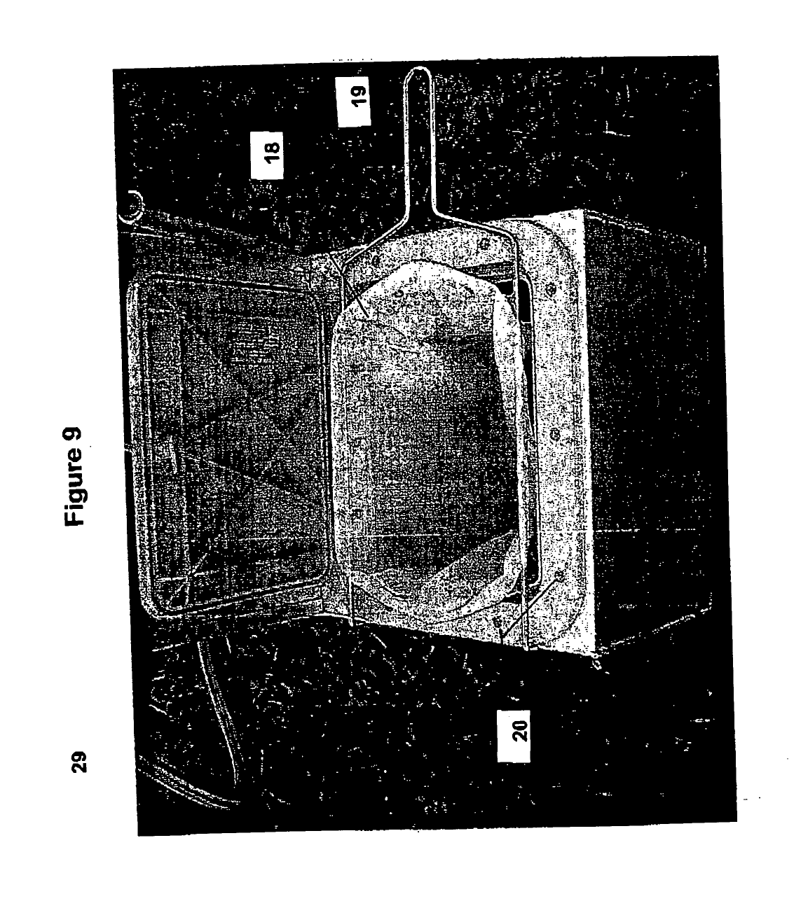

With reference to the FIGS. 1 to 9 there is shown a portable oil filter apparatus 10. The portable oil filter apparatus 10 includes container 11, frame 12 and handle 13. The portable oil filter apparatus 10 has a rear wheel 14 and a front swivel wheel 15. The wheels 14, 15 provide the oil filter apparatus 10 with mobility and front swivel wheel 15 enables the oil filter apparatus 10 to be maneuvered into a desired position.

The container 11 has an opening 16 with a sealable lid 17. Within the opening 16 there is a mesh filter 18 mounted on a filter handle 19 and fixed in position about the opening 16 by snap fit fasteners 20. The mesh filter 18 serves to retain particulate matter from the oil that is larger than the pore size of the mesh filter 18.

Frame 12 serves to house the pump 25 and operatively connected batteries 26. The pump 25 includes electric motor 27 and a operatively connected impellor 28, A flexible hose 29 is connected to the pump outlet 30 and passes through frame outlet 31. The flexible hose 29 is attached to a control nozzle 33. When not in use the control nozzle 33 is positioned within holder 34. The pump inlet 35 is operatively connected to the container 11.

There is a recharging terminal 37 on the frame 12 and electrically connected to one or more of the batteries 26 enabling the batteries 26 to be recharged without their removal.

In another embodiment, the portable oil filter apparatus has a flow rate switch to change the flow rate of the discharging oil. The portable oil filter apparatus is preferably switched to slow flow rate mode when the cookers and deep fryers are washed down with oil to remove matter from the sides and bottom of the equipment. Being in slow flow rate mode, the chances of the oil being splashed outside of the equipment, particularly when the oil is hot, is reduced. When the cleaning is finished, the switch is preferably turned to fast flow rate mode to enable the cooker and fryer to refill quickly. The fast flow rate mode is preferably used to discharge the oil from the apparatus for waste disposal. The oil from the apparatus may be discharged into drums for disposal purposes. Using a flow rate switch and changing the flow rate to provide safe and efficient handling of the oil can effectively reduce the time for filtering and cleaning oil from cookers and fryers.

In use oil from deep fryers or cookers can be safely collected for disposal or storage and/or filtered for re-use. To remove the oil, the cooker or deep fryer is switched off and the oil is allowed to cool. When the oil has sufficiently cooled, the valve associated with the outlet of the cooker or fryer is opened and oil is allowed to discharge into the opening 16 of the container 11. Discharged oil passes into the opening 16 and is filtered by the mesh filter 18. The mesh filter 18 collects particulate matter including batter pieces and bread crumb waste.

When the oil has discharged the outlet valve can be closed and the mesh filter 18 removed so that the collected particulate matter can be discarded. The lid 17 on the container 11 can be closed and sealed and the collected oil taken away for disposal or storage.

Alternatively, the filtered oil can be re-introduced into the cooker or deep fryer for re-use. If filtered oil is to be re-used, the outlet valve remains open and the pump 25 is switched on and filtered oil is re-introduced via the control nozzle 33 into the cooker or fryer and used to wash any residual particulate matter out through the outlet. When all residual particulate matter has been removed, the outlet valve is closed and the re-introduced filtered oil fills the cooker or deep fryer. If the level of oil in the cooker or deep fryer is low, new oil or filtered oil from another cooker or fryer can be added to reach the desired level.

Removal of particulate matter from the oil will extend the operational life of the oil because the smoking point of the oil remains comparatively high without the presence of the particulate matter.

### Advantages

The preferred embodiment of the present invention has the advantage that it is a portable and mobile unit and can be easily maneuvered into position. The preferred embodiment of the present invention is an independent unit that does not require connection to an electrical power outlet or other external connections for operation. The oil filtering apparatus of the preferred embodiment can be used to safely collect and dispose or store oil from cookers and fryers. As well, the oil filtering apparatus of the preferred embodiment is able to filter oil to remove particulate matter and other contaminants and reintroduce the filtered oil to a cooker and fryer thereby extending the operational life of the oil. In this way the preferred embodiment of the oil filtering apparatus is able to recycle oil from cookers and fryers and thereby save money and reduce the amount of waste oil released into the environment.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A portable oil filtering apparatus for use for filtering oil from an oil source comprising:
container means for receiving and holding oil from an oil source;
pump means for pumping and discharging oil from container means, said pump means comprises a power source and pump; and
filter means for filtering oil before it is discharged by pump means wherein the arrangement of the oil filter apparatus provides an operationally independent unit.

2. A portable oil filtering apparatus as claimed in claim 1, wherein the container means comprises a container with an opening for collecting the oil, said container has a funnel and pipe which enables the oil to be collected and passaged into the container.

3. A portable oil filtering apparatus as claimed in claim 1, wherein the container means comprises a sealable container for collecting oil and the filter means includes one or more filters.

4. A portable oil filtering apparatus as claimed in claim 1, wherein the filter means comprises a mesh filter locatable about an opening of the container.

5. A portable oil filtering apparatus for use for filtering oil from an oil source comprising:
a sealable container means for receiving and holding oil from an oil source;
a pump for pumping and discharging oil from said container, said pump is operatively connected to a battery for providing power to the pump; and
one or more filters for filtering oil before it is discharged by said pump wherein the arrangement of the oil filter apparatus provides an operationally independent unit, said oil filtering apparatus has a plurality of wheels for allowing the unit to be maneuverable to a desired position.

6. A portable oil filtering apparatus for use for filtering oil from a deep fryer or cooker comprising:
a sealable container means for receiving and holding oil from an oil source;
a pump for pumping and discharging oil from said container, said pump is operatively connected to a battery for providing power to the pump; and
one or more filters for filtering oil before it is discharged by said pump, said one or more filters comprises a mesh-like filter for filtering large particulate matter, said mesh-like filter is locatable to filter the oil before it enters the container;
wherein the arrangement of the oil filter apparatus provides an operationally independent unit, said oil filtering apparatus has a plurality of wheels for allowing the unit to be maneuverable to a desired position.

7. A portable oil filtering apparatus for use for filtering oil from a deep fryer or cooker as claimed in claim 6 wherein the filtered oil can be reintroduced to the deep fryer or cooker through a flexible hose connected to a pump outlet.

8. A portable oil filtering apparatus for use for filtering oil from a deep fryer or cooker as claimed in claim 6 wherein the filtered oil is sealed in the container and removed for disposal,

9. A portable oil filtering apparatus for use for filtering oil from a deep fryer or cooker as claimed in claim 6 wherein the filter is locatable about an opening in the container, said filter is removable for discarding the collected particulate matter.

10. A method for removing oil from an oil source for filtering and re-use, using the portable filter apparatus as claimed in claim 6, said method including:
positioning said portable oil filtering apparatus adjacent a deep fryer or cooker outlet so that oil discharged from the outlet enters said container;
opening the deep fryer or cooker outlet to allow oil to discharge;
closing the deep fryer or cooker outlet after the oil has discharged; and
activating the pump to reintroduce the filtered oil into the deep fryer or cooker.
